(19) United States
(12) Patent Application Publication
(10) Pub. No.: US 2022/0076173 A1
(43) Pub. Date: Mar. 10, 2022

(54) METHODS AND SYSTEMS FOR ITINERARY CREATION

(71) Applicant: TravSolo, Inc., Brooklyn, NY (US)

(72) Inventor: Chizoba Anyaoha, Brooklyn, NY (US)

(73) Assignee: TravSolo, Inc., Brooklyn, NY (US)

(21) Appl. No.: 17/188,827

(22) Filed: Mar. 1, 2021

Related U.S. Application Data
(60) Provisional application No. 63/076,330, filed on Sep. 9, 2020.

(51) Int. Cl. G06Q 10/02; G06Q 10/10

(52) U.S. Cl. CPC G06Q 10/025; G06Q 10/1095

(57) ABSTRACT

Disclosed are methods, systems, and computer-readable medium to perform operations including: receiving a request from a user to create an itinerary; in response, determining a current location of the user, a search radius for the itinerary, interests of the user, and whether the user is interested in meeting other users; generating the itinerary for the user, the itinerary comprising a plurality of categorized activities; generating a graphical user interface (GUI) that displays an activity of the plurality of categorized activities, the activity associated with an activity category; displaying the GUI on a display device of a computing device associated with the user; in response to receiving an input indicating that the user has accepted the activity, displaying a graphical feature that enables the user to upload media associated with the activity; and in response to receiving uploaded media, associating the uploaded media with the activity.

### CROSS-REFERENCE TO RELATED APPLICATIONS

This application claims the benefit of U.S. Application Ser. No. 63/076,330 filed on Sep. 9, 2020, the entire contents of which are incorporated by reference in its entirety.

### TECHNICAL FIELD

This description relates to methods and systems for itinerary creation.

### BACKGROUND

A travel itinerary is a schedule of events that relate to planned travel or planned activities.

### SUMMARY

Existing itinerary solutions fail to focus on the needs of solo travelers and travelers, such as the need to quickly plan trips, meet other travelers or locals, and have safety measures in place.

This disclosure describes a computer-based travel planning system that provides a service to users to quickly and easily create travel itineraries. The travel planning system also performs actions, such as automatically performing reservations and scheduling meet ups, in connection with the created travel itineraries. In one embodiment, to create an itinerary, the travel planning system determines a location of the user, a desired length of the itinerary, an area that user is interested in exploring (e.g., based on a radius from a desired location), categories of activities that are of interest to the user, sub-categories of activities that are of interest to the user, whether the user is interested in sharing the itinerary and/or the user's location with specified contacts, and whether the user is interested in meeting other users (e.g., other travelers or locals). Based on this information, the travel planning system generates an itinerary (also referred to in this disclosure as an “itineready”) that includes activities scheduled for the user. The itinerary can span any number of days up to the length of the trip.

Aspects of the subject matter described in this specification may be embodied in methods to perform operations including: receiving a first request from a first user to create an itinerary; in response to receiving the request, determining a current location of the first user, a search radius for the itinerary, interests of the first user, sub-interests of the first user, and whether the first user is interested in meeting other users; based on the current location of the first user, a search radius for the itinerary, interests of the first user, sub-interests of the first user, and whether the first user is interested in meeting other users, generating the itinerary for the first user, the itinerary comprising a plurality of categorized activities; generating a graphical user interface (GUI) that displays a first activity of the plurality of categorized activities, wherein the first activity is associated with an activity category, and wherein the GUI includes: a first graphical feature that enables the first user to accept the first activity, a second graphical feature that enables the first user to switch to a different activity, and a third graphical feature enables the first user to change to a different activity category; displaying the GUI on a display device of a computing device associated with the first user; in response to receiving a first input indicating that the first user has accepted the first activity, displaying a fourth graphical feature that enables the first user to upload media associated with the first activity; and in response to receiving uploaded media, associating the uploaded media with the first activity.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the operations further including: in response to receiving a second input indicating to switch to the different activity, determining a second activity of the plurality of categorized activities that is associated with the activity category; and displaying information indicative of the second activity on the GUI.

In some implementations, the operations further including: in response to receiving a second input indicating to change to the different activity category, determining a second activity of the plurality of categorized activities that is associated with the different activity category; and displaying information indicative of the second activity on the GUI.

In some implementations, the first activity is a meeting with a second user, and generating the itinerary for the first user includes: determining first meeting preferences for the first user, the first meeting preferences comprising at least one of location for the meeting, food preferences, personal preferences, number of people in the first user's party, number of people that the first user is interested in meeting, a type of meetup, or the first user's schedule availability; determining second meeting preferences for the second user; and executing a matching algorithm that uses the first and second meeting preferences to match the first user with the second user.

In some implementations, the operations further including: receiving at least one pre-generated itinerary from a database, each pre-generated itinerary associated with at least one location and comprising one or more predetermined activities; generating a second GUI that provides the at least one pre-generated itinerary; and receiving a second input indicative of selection of one of the at least one pre-generated itinerary.

In some implementations, the operations further including determining that the itinerary has been completed; and in response, generating a video based on at least one of the itinerary or the media uploaded by the user, wherein the video highlights the itinerary.

In some implementations, the operations further including displaying a fifth graphical feature that enables the first user to play the generated video; and in response to receiving a second input indicating to play the generated video, playing the generated video on the GUI.

The subject matter described in this specification can be implemented in particular implementations to realize one or more of the following advantages. The disclosed travel planning system that provides travelers (e.g., solo travelers) with the tools to create itineraries on the go. The disclosed travel planning system also allows users to meet people and to bring back home a travel story to share. Further, the disclosed travel planning system provides a service to users to quickly and easily create travel itineraries. The travel planning system also performs actions, such as automatically performing reservations and scheduling meetings, in connection with the created travel itineraries.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates an example travel planning system, according to some implementations, according to some implementations of the present disclosure.

FIG. 2 illustrates a block diagram of the meeting planning module, according to some implementations, according to some implementations of the present disclosure.

FIG. 3A, FIG. 3B, and FIG. 3C illustrate an example software application associated with the travel planning system, according to some implementations of the present disclosure.

FIG. 4 illustrates a flowchart of an example method, according to some implementations of the present disclosure.

FIG. 5 illustrates an example system, according to some implementations of the present disclosure.

Like reference numbers and designations in the various drawings indicate like elements.

### DETAILED DESCRIPTION

This disclosure describes a computer-based travel planning system that provides a service to users to quickly and easily create travel itineraries. The travel planning system also performs actions, such as automatically performing reservations and scheduling meetings, in connection with the created travel itineraries. In one embodiment, to create an itinerary, the travel planning system determines a location of the user, a desired length of the itinerary, an area that user is interested in exploring (e.g., based on a radius from a desired location), categories of activities that are of interest to the user, sub-categories of activities that are of interest to the user, whether the user is interested in sharing the itinerary and/or the user's location with specified contacts, and whether the user is interested in meeting other users (e.g., other travelers or locals). Based on this information, the travel planning system generates an itinerary (also referred to in this disclosure as an “itineready”) that includes activities scheduled for the user. The itinerary can span any number of days up to the length of the trip.

Once the itinerary is created, the travel planning system provides the user, e.g., via a graphical user interface, with an activity from the itinerary. The travel planning system allows the user to accept the activity or to request a new activity. The new activity can be from the same category as the original activity or can be from a different category. If a user indicates that an activity is being performed, the travel planning system allows the user to upload media (e.g., notes, photos, and videos) that are automatically associated with the itinerary and/or with the activity that is being performed. Once the itinerary is complete, the travel planning system can turn into video formatting. The video showcases the user's entire trip, including the places visited by the user and the media uploaded by the user. The video can be shared privately through download or publicly through the user's social media. The user can share the generated media using the user's social media and/or can share the media with other users of the travel planning system.

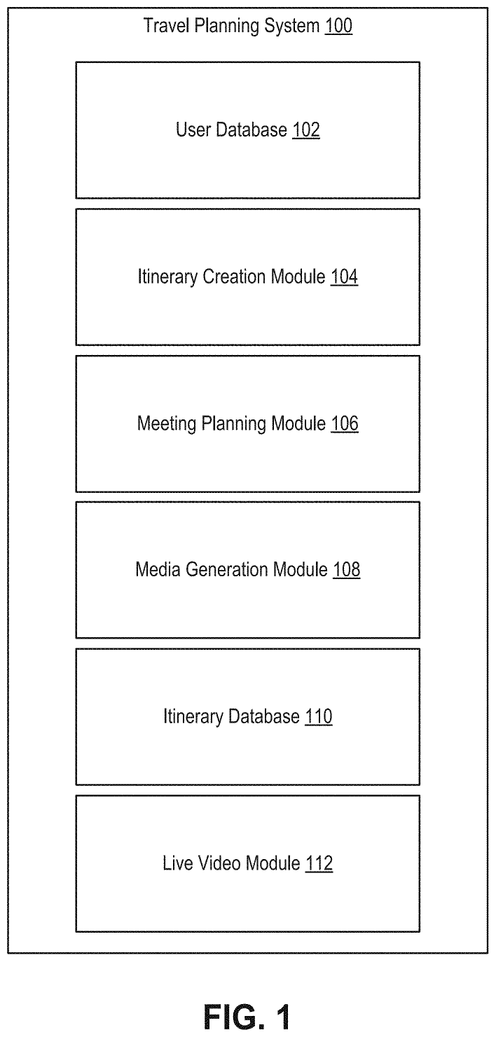

FIG. 1 illustrates an example travel planning system 100, according to some implementations. As shown in FIG. 1, the travel planning system 100 includes a user database 102, an itinerary creation module 104, a meeting planning module 106, a media creation module 108, and an itinerary database 110. As described in more detail below, the travel planning system 100 is configured to: (i) generate a dynamic travel itinerary for a user, (ii) automatically adjust the dynamic travel itinerary (e.g., in response to requested changes or cancellations), (iii) enable the user to journal performed activities (e.g., by uploading media), and (iv) automatically generate media based on the itinerary and/or the media uploaded by the user.

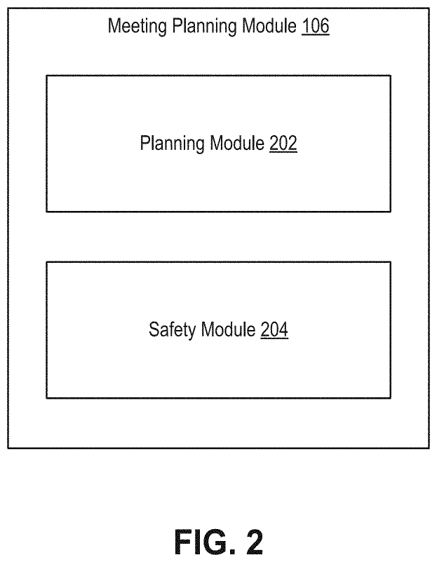

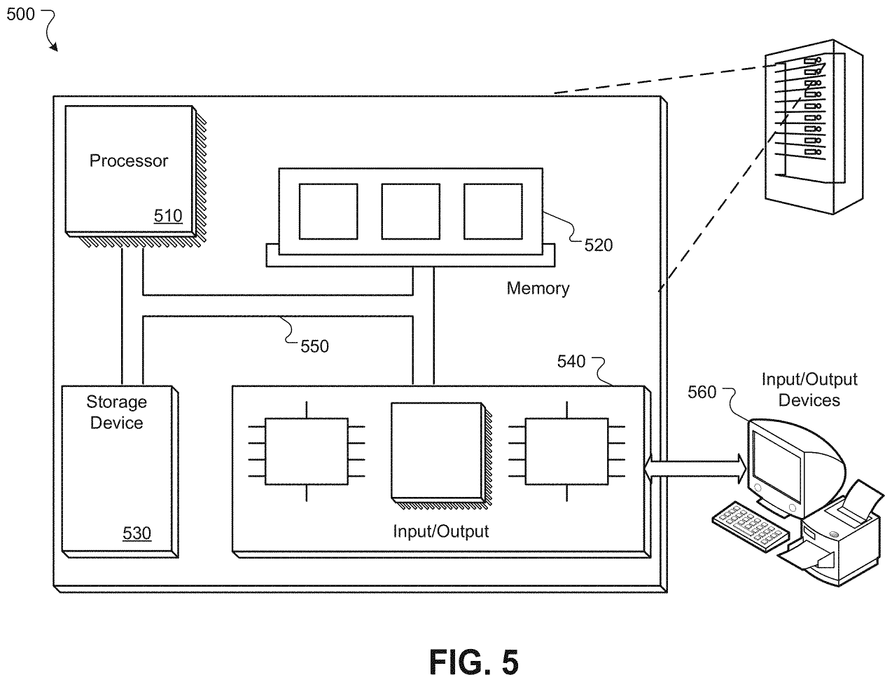

In some embodiments, the travel planning system 100 can be a computer system that is the same as, or similar to, the system 500 of FIG. 5. Note that the travel planning system 100 is shown for illustration purposes only, as the system can include additional components and/or have one or more components removed without departing from the scope of the disclosure. Further, note that the various components of the travel planning system 100 can be arranged and connected in any manner. In the following discussion of the travel planning system 100, reference is also made to FIG. 2.

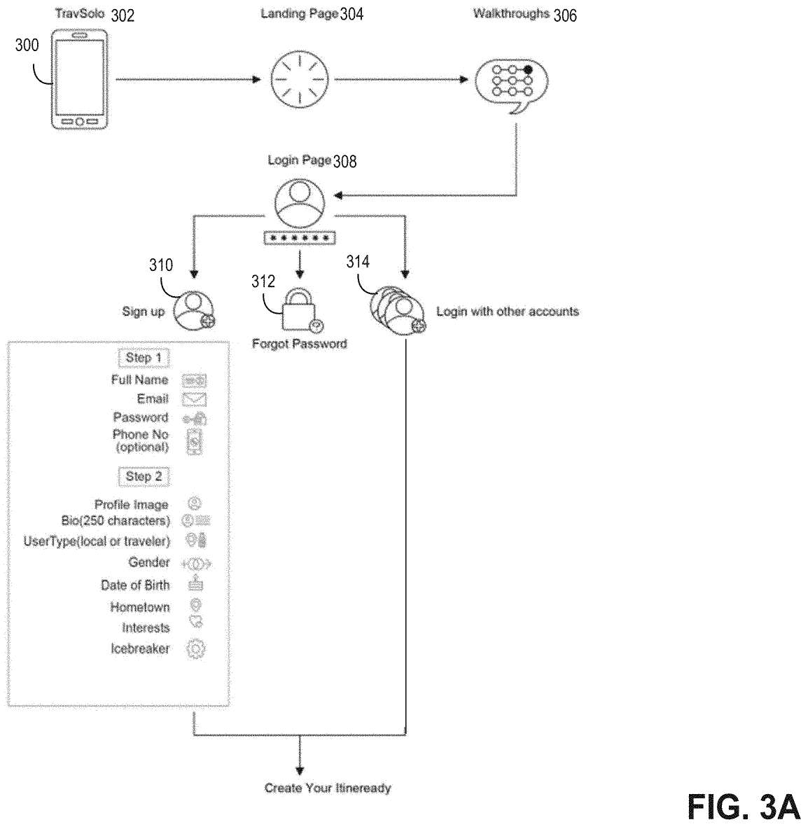

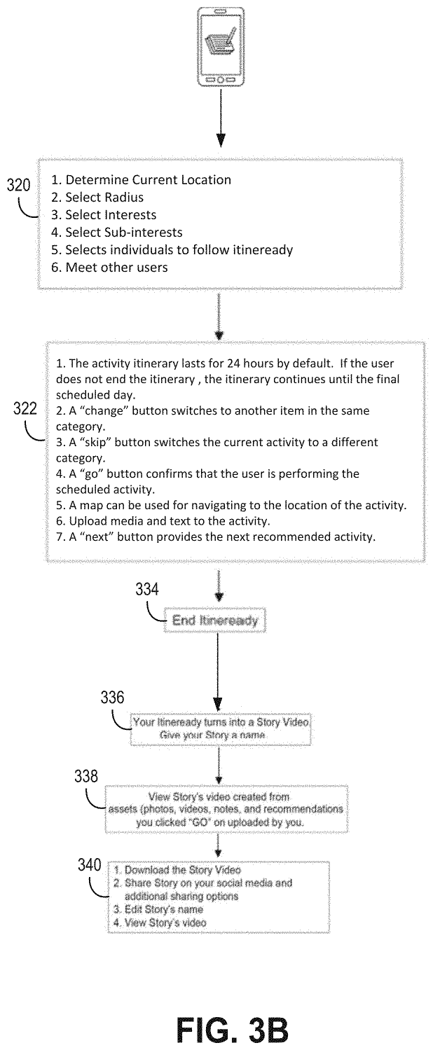

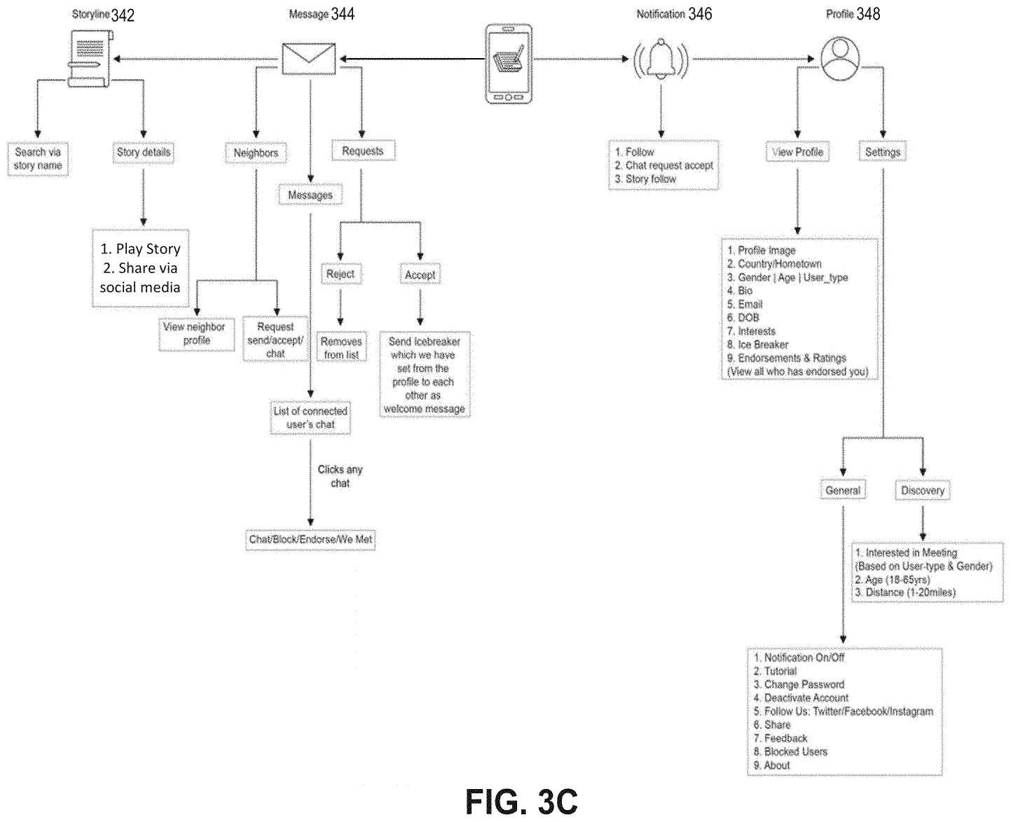

In some embodiments, the user database 102 includes profiles of one or more users that have registered or created accounts with the travel planning system 100. A user can create an account, for example, using software that is associated with the travel planning system 100. FIGS. 3A, 3B, and 3C describe an example software associated with the travel planning system 100. Further, a user profile can include user information, such as a full name, an email address, a user type, a phone number, a user biography (“bio”), gender, date of birth, hometown, user interests (e.g., categories of activities that are of interest to the user), and an icebreaker. The user type identifies the user as a “local” and/or as a “traveler.” In examples where the user is associated with more than one user type, the travel planning system 100 can designate one of the user types as active. For instance, if a user is associated with both user types is currently traveling, the travel planning system 100 designates the user type “traveler” as active for the user, and if the user is not traveling, the travel planning system 100 designates the user type “local” as active for the user.

Additionally and/or alternatively, a user profile can include encrypted login information (e.g., user names and passwords), encrypted payment information (e.g., credit card numbers), and/or encrypted identifying documents (e.g., travel documents, such as a visa). Further, a user profile can include information indicative of individuals associated with the user. The individuals can be social media contacts, users of the travel planning system 100 with whom the user has interacted with previously, and/or known companions of the user (e.g., partner, travel companion, etc.). The user profile can also include information of other accounts of the user, for example, on other software platforms. The other user accounts can include social media accounts, email accounts, and/or travel rewards accounts. Furthermore, a user profile can include preferred travel preferences, such as preferred seats, preferred airlines, preferred hotels, budget ranges, and preferred modes of transportation.

In some embodiments, the itinerary creation module 104 is configured to create a pre-trip itinerary and/or an activity itinerary for the user. A pre-trip itinerary includes logistical information for a trip, such as lodging reservations (e.g., a hotel, hostel, or any other accommodation), transportation reservations (e.g., trains, rental cars, flights, ride-shares, etc.), and travel documentation (e.g., visas, travel insurance, health documents, etc.). An activity itinerary includes activities scheduled for the user during the trip, such as tourist destinations, sightseeing activities, entertainment events, eating, drinking, and meeting other travelers or locals. Within examples, a user can request the itinerary creation module 104 to create pre-trip itinerary, an activity itinerary, or both for a trip. Specifically, the user can create a pre-trip itinerary and an activity itinerary prior to a trip, can create the pre-trip itinerary prior to the trip and the activity itinerary during the trip, or can create only the activity itinerary before or during the trip. Note that the front-end of the itinerary creation is explained in more detail in FIG. 3B.

In some embodiments, the itinerary creation module 104 creates a pre-trip itinerary based on input information that includes user information and/or a user input. In one example, in response to receiving a request to create a pre-trip itinerary from a user, the itinerary creation module 104 obtains the user's profile from the user database 102. Additionally and/or alternatively, the itinerary creation module 104 requests information from the user, which the user can provide via a user input. In particular, the itinerary creation module 104 requests information that is not included in the user profile or that would be needed to complete reservations for the trip. Example requested information includes information about trip destinations, a length of the trip (e.g., in each destination), expected baggage (e.g., carry-on and check-in baggage), preferred flight seats, preferred travel providers (e.g., hotels, airlines, ride-share companies), preferred mode of transportation, purpose of the trip (e.g., sightseeing or leisure), travel insurance, travel add-ons, and travel companions. In scenarios where a travel companion is traveling with the user, the itinerary creation module 104 can create a co-itinerary for the users. Specifically, if the travel companion is registered with the travel planning system 100, the itinerary creation module 104 can retrieve the travel companion's user profile from the user database 102 and/or request information from the travel companion.

In some embodiments, the itinerary creation module 104 uses the input information to generate a proposed pre-trip itinerary that includes travel dates, transportation, lodging, and/or travel documentation applications (e.g., visa application or health information request from healthcare provider). To generate the proposed pre-trip itinerary, the itinerary creation module 104 uses the input information to determine proposed travel dates (or several sets of proposed travel dates). For example, the itinerary creation module 104 selects travel dates that are within a window, e.g., one or two days, from the travel dates provided by the user. Once the proposed dates are selected, the itinerary creation module 104 uses the input information to search travel databases (e.g., Internet travel databases) for transportation. The itinerary creation module 104 then selects one or more proposed transportation reservations, e.g., based on factors such as price and preferred transportation providers. Similarly, the itinerary creation module 104 uses the input information to search travel databases (e.g., Internet travel databases) for one or more proposed lodging reservations. Further, the itinerary creation module 104 determines based on the destination and the user's travel documentation (e.g., citizenship) whether the user requires a visa or other documentation (e.g., health documents). Based on the determination, the itinerary creation module 104 generates a visa application or prepares a request to acquire other documentation (e.g., from a healthcare provider of the user).

In some embodiments, the itinerary creation module 104 provides the proposed pre-trip itinerary to the user, perhaps by generating an interactive interface that includes the proposed pre-trip itinerary. The itinerary creation module 104 then requests the user to review the proposed pre-trip itinerary. The user can modify the pre-trip itinerary or can approve the pre-trip itinerary. In examples where the user modifies the pre-trip itinerary, the itinerary creation module 104 responsively and automatically modifies the pre-trip itinerary to adjust for the modification. As an example, if the user changes a travel date in the pre-trip itinerary, the itinerary creation module 104 can determine new reservations for the new travel date, and can automatically present an updated pre-trip itinerary to the user, perhaps via the interactive interface. Once the user approves the pre-trip itinerary, the itinerary creation module 104 autonomously performs the bookings for the user. For example, the itinerary creation module 104 uses application programming interfaces (APIs) to communicate with external systems to perform the reservations. The itinerary creation module 104 then generates a summary of the booking information and provides the summary to the user. In examples where the itinerary creation module 104 is creating a co-itinerary, the itinerary creation module 104 provides the summary to each user associated with the co-itinerary.

In some embodiments, the itinerary creation module 104 can modify the pre-trip itinerary after it has been created, perhaps based on a user input or an input from another computer system. As an example, if the itinerary creation module 104 receives information indicating that a reservation in the pre-trip itinerary has been cancelled, the itinerary creation module 104 responsively modifies the pre-trip itinerary by removing the reservation and/or making a new reservation.

In some embodiments, the itinerary creation module 104 also creates an activity itinerary based on input information that includes user information and/or a user input. In an example, in response to receiving a request to create an activity itinerary from a user, the itinerary creation module 104 obtains the user's profile from the user database 102. Additionally and/or alternatively, the itinerary creation module 104 requests information from the user, which the user can provide by a user input. In particular, the itinerary creation module 104 requests information that is not included in the user profile or that would be needed to generate the activity itinerary (e.g., to complete activity reservations for the trip). Example requested information includes a primary purpose of the trip (e.g., sightseeing, attending an entertainment event, relaxation and recuperation, etc.), a start date and an end date for the activity itinerary, a start time and an end time for each day, a search radius (e.g., from a specified location, such as the user's lodging), the user's preferred restaurants and activities, whether to schedule meetings with locals and/or other travelers, the type of meeting to schedule, categories of activities that are of interest to the user, and/or sub-categories of activities that are of interest to the user. In some examples, the information is requested by providing the user, perhaps via an interactive interface, with different categories of activities, such as food & drink, nightlife, adventure, arts & museums, sports, and wellness. The user selects the categories of interest, and at least one sub-interest is provided for each category of interest. The user then selects sub-categories of interest.

In some embodiments, the itinerary creation module 104 uses the input information to create an activity itinerary. The time period covered by the activity itinerary can be customized, perhaps based on user input, and can range from one day to several days (e.g., up to the length of the trip). An activity itinerary includes activities organized according to categories (e.g., food & drink, nightlife, adventure, arts & museums, sports, and wellness). The itinerary creation module 104 creates an activity itinerary by determining the activities to include in each category of interest to the user. In some embodiments, the itinerary creation module 104 includes at least one activity in each category. In one example, the itinerary creation module 104 uses the input information to extract from the itinerary database 110 activities that match the user's selected interests, sub-interests, and/or preferences. In another example, the itinerary creation module 104 uses the input information to search an external database (e.g., an Internet database) for activities that are associated with the user's selected categories of interest, the user's selected sub-interests, and/or the user preferences.

In some embodiments, once the activities are selected, the itinerary creation module 104 can rank the activities, e.g., using a ranking algorithm, within each category of interest and/or sub-category of interest. The ranking algorithm calculates a score for each selected activity based on one or more factors. Example factors include similarity to a user's interests and/or preferences, whether the activity has been performed by a connection of the user, user reviews (e.g., from the itinerary database 110 or from an Internet database), and/or similarity of the user's profile to the profile of users that performed the activities.

Once the activities are ranked, the activity itinerary is provided to the user. Specifically, the activity itinerary provides the user with a top-ranked activity (e.g., that has not yet been performed) from one of the categories selected for the user. The category from which the activity is selected is based on factors including a current date/time, the user's current location, and/or the activities that the user has completed. The user can confirm that the user is performing the activity or can request a different activity from the same category or a different category. If the user requests an activity from the same category, the itinerary creation module 104 can select the activity subsequent in ranking to the first selected activity. And if the user requests the category to be changed, the itinerary creation module 104 can select a new category, e.g., based on factors such as a current date/time, the user's current location, and/or the categories of the activities that the user has completed. The itinerary creation module 104 then provides the user with the top-ranked activity that the user has not performed from the new category. As such, the itinerary creation module 104 dynamically modifies the activity itinerary in response to user input.

In some embodiments, the itinerary creation module 104 determines that the user has requesting meeting others, such as travelers or locals, during the trip. In response, the itinerary creation module 104 communicates with the meeting planning module 106 in order to request a meeting to be scheduled for the user. As described in more detail below in FIG. 2, the meeting planning module 106 determines one or more individuals with which to schedule the user's meeting. Additionally, the meeting planning module 106 determines a location for the meeting. The meeting planning module 106 provides the meeting information to the itinerary creation module 104, which includes the meeting information in the activity itinerary.

FIG. 2 illustrates a block diagram of the meeting planning module 106, according to some implementations. As shown in FIG. 2, the meeting planning module 106 includes planning module 202 and safety module 204. The planning module 202 is configured to schedule a meeting for a user, perhaps with another traveler or local. The user may have requested the meeting to be arranged with another user. Alternatively, the user may have activated a feature that requests the user to be notified when a potential user match is nearby. In this case, the planning module 202 continuously and/or periodically attempts to find a match for the user, for example, until the feature is deactivated.

In some embodiments, the planning module 202 executes a matching algorithm in order to match a user with one or more other users. The matching algorithm receives as input a user's preferences including a radius for the meetup and/or search, food preferences (e.g., preferred cuisine or dietary restrictions), personal preferences, number of people in the user's party, number of people that the user is interested in meeting, types of meetups, and/or the user's schedule availability. The types of meetups can include a meeting with a local, a networking meeting, a friendship meeting, and a dating meeting. The planning module 202 can determine the input information based on previously provided user input or by prompting the user to provide the user input.

In some embodiments, the matching algorithm uses the input information to find a match for the user. In one example, the matching algorithm compares the user's input information to information provided by other users that have also requested a meeting or indicated that they are available for meetings. The matching algorithm can compare age, height, geographic location, neighborhood, ethnicity, religion, dietary restrictions, allergies, budget, type of meeting place (e.g., public parks, restaurants, cafes, etc.) or activity (e.g., drinking, eating, outdoor activity, etc.), drinking preference (e.g., sober), or preferred number of meeting participants (e.g., 1-on-1 meeting or a group meeting). In some examples, the matching algorithm uses filters or screens to limit the results. The filters include a maximum distance from a current location, food choices (e.g., dietary restrictions), religion, or any other user specified filter. In some embodiments, the matching algorithm scores potential matches, for example, based on an extent of similarity between the preferences and/or interests of the user and the preferences and/or interests of the potential matches.

In some embodiments, after the matching algorithm selects a match, the planning module 202 selects a meeting location. In one example, the planning module 202 selects more than one potential location based on factors such as the current location and/or the preferences of the matched users. The planning module 202 then provides the users with the potential locations and provides instructions to the users to rank the potential locations. Based on the user inputs, the planning module 202 can select one of the locations for the meeting. In some examples, if the user do not reach a decision within a threshold amount of time, then the planning module 202 automatically selects a meeting location based on proximity. Additionally, the planning module 202 can select a meeting time and date. In an example, the planning module 202 accesses the calendars of the matched users to find a common availability. Once a time and date is selected, the planning module 202 can make a reservation at the meeting location (if a reservation is needed or preferred). In some embodiments, the users can select to bypass the planning module 202 and can communicate directly with one another to schedule a meeting.

In some embodiments, the planning module 202 generates a user interface that includes information indicative of the meeting. The planning module 202 then provides the user interface for display on computer devices operated by the users. In some embodiments, the information included in the graphical interface includes identifying information of the users (e.g., name and picture), information indicative of the meeting location, reservation details (if a reservation is created), and/or a meeting time.

In some embodiments, the safety module 204 includes safety features that protect users that are participating in a meeting. The safety features include location tracking, one-touch emergency calling, and sharing location and/or meeting information with contacts. Additionally, the safety module 204 includes an accountability system. If a user does not participate in a meeting they agreed to attend, then the user is subject to a penalty (e.g., assigned a lower rating or given a warning). Additionally, the user will have to provide a reasonable excuse to the other party in the meeting. The other party will have to approve the excuse. In some embodiments, after a predetermined number of unattended meetings, a user can be banned from the travel planning system 100 for a period of time, perhaps 7 days, 14 days, or 30 days, depending on the severity.

In one embodiment, the penalty system involves a three-strike rule. The penalty for the first strike (i.e., the first violation) is an account hold for a first period of time (e.g., 24-72 hour account hold). The penalty for the second strike is an account hold for a second period of time longer than the first period of time (e.g., a one month hold). The penalty for the third strike is a permanent ban. In another embodiment, the penalty system involves the three-strike rule in addition to a reactivation fee. The reactivation fee includes at least the costs that resulted from breaking the policy (e.g., cancellation fees).

In some embodiments, the meeting planning module 106 allows users to communicate using a software application associated with the travel planning system 100. In one example, the meeting planning module 106 allows users to schedule video or voice meetings in public or private virtual rooms that are hosted by the travel planning system 100.

Returning to FIG. 1, the media creation module 108 is configured to generate the media based on the itinerary and/or the media uploaded by the user. As described above, the travel planning system 100 allows the user to upload media, such as text, photos, or videos while the user is performing activities scheduled in the itinerary. When the user uploads media, the media creation module 108 associates the media with the activity that is being performed. For example, the media creation module 108 can add a metatag to the media that associates the media with the activity. The media creation module 108 does so for each instance of media that is uploaded. Then, when an itinerary is completed, the media creation module 108 generates media (e.g., a video, a slideshow, a journal, etc.) that highlights the activities performed by the user from the itinerary. In this way, the media creation module 108 converts the user itinerary into a story media that can be either downloaded or share publicly on social media. The user can share the itinerary with others, publicly or privately.

In some embodiments, the completed itinerary can be stored in an itinerary database 110. Additionally, the completed itinerary can be associated with an anonymized version of the user profile. The itinerary database 110 can store completed itineraries as historical data that the itinerary creation module 104 can use to create new itineraries. As an example, the itinerary creation module 104 can use search the completed itineraries based on the profiles of the users for which the itineraries were generated. Thus, when the itinerary creation module 104 is creating an itinerary for a user, the itinerary creation module 104 can search for itineraries that were created for users with similar profiles to the user (e.g., same age, gender, religion, interests, etc.). In some examples, the itinerary database 110 can also include user reviews of activities.

In some embodiments, the itinerary database 110 includes pre-generated itineraries that include predetermined activities. A pre-generated itinerary is associated with one or more locations and can include one or more activities (e.g., restaurants, sightseeing activities, etc.) in those locations. A pre-generated itinerary can also be associated with one or more characteristics or interests that can be used to categorize the itinerary. Additionally, the one or more characteristics can be used as identifiers (e.g., tags) for the pre-generated itinerary. The travel planning system 100 can search the itinerary database 110 using the identifiers as keywords and can populate the results of all pre-generated itineraries that are associated with the searched keywords. For example, a pre-generated itinerary for location “A” and that includes educational activities is associated with the identifiers “location A,” “A,” “education,” among other examples.

In some embodiments, the travel system 100 receives pre-generated itineraries from external sources, such as online databases. In these embodiments, the travel planning system 100 can be associated with travel agencies to host itineraries that users of the travel planning system 100 can purchase. In an example, if a user selects a pre-generated itinerary from a particular agency, the user can be assigned to a travel agent associated with the travel agency that provided the pre-generated itinerary. Furthermore, users can view the pre-generated itineraries associated with particular agencies and/or with particular agents. This feature is particularly useful if the user is traveling to a location with which they have very little experience (e.g., speak a different language).

In some embodiments, the travel planning system 100 includes a live video module 112. The live video module 112 allows users to upload or stream videos that can be viewed by other users of the system, e.g., in real-time or within a threshold amount of time after the video has been uploaded. In one example, when an activity is provided to a user in an itinerary, the user can view one or more videos from other users that are currently performing or have recently performed the activity. To illustrate this example, when the user is provided a restaurant as a suggested activity, the user can view videos that are currently being streamed or have been uploaded by other users that are currently at the restaurant or have recently been at the restaurant. In another example, a user can view a map that provides an indication of locations where user videos are currently being streamed or have recently been uploaded. The user can then use the indication to select and view a video of interest. These videos provide users with a more realistic representation of the suggested activity, and therefore, can assist users in making decisions on activities.

FIGS. 3A, 3B, and 3C illustrate an example software application associated with the travel planning system, according to some implementations. The software application is executed by a computing system, perhaps a mobile device, operated by a user. The software application communicates with the travel planning system 100, perhaps via the Internet or any other wired or wireless communications system.

FIG. 3A illustrates an example sign-up or login workflow for the software application. As shown in FIG. 3A, the software application is launched at 302, perhaps on a mobile device 300 of a user. At 304, the software application generates a landing page, and displays the landing page on a display of the mobile device 300. At 306, the software application generates a walkthrough tutorial, and displays the tutorial on the display. In some examples, the software application only generates the walkthrough tutorial if the application is being executed for the first time on the mobile device 300. At 308, the software application generates a login page and displays the login page on the display. In some examples, the login page includes at least three graphical elements, each associated with a respective feature 310, 312, 314. The feature 310 enables a user to sign up to create an account with the travel planning system 100. The sign up process involves two steps. In a first step, the user provides their full name, email, password, and phone number. In a second step, the user provides a profile image, a short biography (e.g., word or character limited), a user type (e.g., a local and/or a traveler), gender, date of birth, hometown, interests, and an icebreaker. In some examples, one or more of the requested information is optional. The feature 312 enables a user who has created an account with the travel planning system 100 to reset a password associated with the account. The feature 314 enables the user to log in to an account using the login information of other services, such as email accounts or social media accounts.

Once a user has logged into their account, the user can perform actions in connection with their account. As described in more detail below, a traveler can create or use an itinerary, communicate with other users, view storylines, review notifications, and manage their profile. Similarly, a local can communicate with other users, view or edit a calendar, view storylines, review notifications, and manage their profile.

FIG. 3B illustrates an example itinerary creation workflow 320 for the software application. In a first step, the software application determines the location for which the user wants to create an itinerary. In one example, the location is the user's current location. In this example, the software application can determine the user's current location by requesting the user to input their current location or by using the mobile phone's location. In a second step, the software application requests the user to provide a search radius for the itinerary. The software application limits the activities in the itinerary to locations within the provided radius. In a third step, the software application requests the user to select interests. The software application can provide the user one or more categories of activities, and the user can provide inputs indicative of the categories of interest. Example categories include food and drink, nightlife, adventure, arts and museums, sports, and wellness.

In a fourth step, the software application requests the user to select one or more sub-interests for the one or more selected interests. For example, the software application can provide the user with sub-categories of activities within each selected activity category. For instance, the sub-categories of the food and drink category include cuisines, types of drinks, and type of establishment (e.g., restaurant, pub, bar, etc.). In a fifth step, the software application requests the user to selects individuals to follow the created itinerary. The individuals can also be users of the software application or may be contacts of the user. In a sixth step, the software application requests the user to indicate whether the user is interested in scheduling meetings with other users. If the user indicates that the user is interested in scheduling meetings, the software application can request additional information that can be used by the matching algorithm to schedule a meeting for the user. For example, the software application can request a user's preferences including a radius for the meetup and/or search, food preferences (e.g., preferred cuisine or dietary restrictions), personal preferences, number of people in the user's party, number of people that the user is interested in meeting, types of meetups, and/or the user's schedule availability. The types of meetups can include a meeting with a local, a networking meeting, a partnership meeting, a friendship meeting, and a dating meeting.

Specifically, after the workflow 320 is completed, the software application creates an activity itinerary for the user. The software application then provides the created itinerary to the user, for example, by generating an interface that includes the itinerary, and displaying the interface on the display of the user's device.

FIG. 3B also illustrates features 322 of an interface that displays the created itinerary. As shown in features 322, the activity itinerary lasts for 24 hours by default. If the user does not end the itinerary, the itinerary continues until the final scheduled day. At any given time, the interface displays a current activity for the user from the itinerary. The interface includes a feature (e.g., a clickable button) that allows the user to confirm that the user is performing the scheduled activity. The interface also includes a feature that allows the user to switch the current activity with another activity in the same category. Further, the interface includes a feature that allows the user to skip the activity and request a new activity from a different category. The interface further includes a feature that allows a user to replace a suggested activity in the itinerary with their own activity. Adding the activity can be performed manually by the user (e.g., the user provides an input indicative of the activity) or by providing the user with a search toolbar that allows the user to search for and select a replacement. The interface also includes a feature that allows the user to access a map that can be used for navigating to the location of the activity. Furthermore, the interface includes a feature that allows the user to upload media to be associated with the activity. Yet further, the interface includes a button that provides the user with the next recommended activity in the itinerary.

The user has the option of completing the itinerary, at which point, the itinerary ends as shown by 334. Alternatively, the itinerary can be ended by the user at any time. Once the itinerary ends, a media (also referred to as a “story” or “storyline”) based on the itinerary is generated, as shown by 336. The user can provide a name for the story. At 338, the user can view the generated media. As shown in FIG. 3B, the generated media can, for example, be a video that is generated based on the media (e.g., photos, videos, notes) uploaded by the user and the activities performed by the user. As shown by 340, the user can download the generated media, can shared the generated media on social media or other platforms, can edit the generated media's name, and can view the generated media.

FIG. 3C illustrates additional features of the software application. As shown in FIG. 3C, the software application can include a “Storyline” interface 342, a messaging interface 344, a notification feature 346, and a profile interface 348. In an example, the “storyline” interface 342 allows the user to search for stories (that is, media) created by the user or shared with the user. Additionally, the “storyline” interface 342 allows the user to view details of and play the stories created by the user or shared with the user. Further, the “storyline” interface 342 allows the user to share stories created by the user. The messaging interface 344 allows the user to view requests for meetings from other users. The user can accept or reject those meetings. In some examples, if the user rejects a meeting from another user, the user has the option of blocking the other user from viewing their profile or communicating with them. Alternatively, if the user accepts the meeting, the software application automatically sends the user's icebreaker to the other user as a welcome message. The messaging interface 344 also allows the user to view the profiles of other users that are in the user's vicinity. Those users are also referred to as neighbors and have activated a feature that allows other users to view their profiles when nearby (e.g., within a predefined distance). The user can view the profiles of neighbors or can request/accept/send chat requests to the neighbors.

The notification feature 346 provides the user with notifications indicative of a follow request, an acceptance of a chat request, or a story/itinerary follow from another user. The profile interface 348 allows the user to view or modify their profile or settings of the software application. The profile information that can be viewed or modified by the user includes a profile image, country/hometown information, gender, age, user type, bio, email, date of birth, interests, icebreaker, and/or endorsements and ratings. The user can view or modify general settings or discovery settings. The general settings include a notification turn on/off, a tutorial turn on/off, password settings, account deactivation. Additionally, the user can share the software application with other users, provide feedback, view blocked users, and view information about the software application. The discovery settings include settings associated with the discovery feature of the software application. As described previously, the discovery feature allows users to view the profiles of other nearby users. Both users must activate the feature. The discovery feature settings include information indicating whom the user is interested in meeting (e.g., user type, gender, age) and a distance within which other users can view the user's profile.

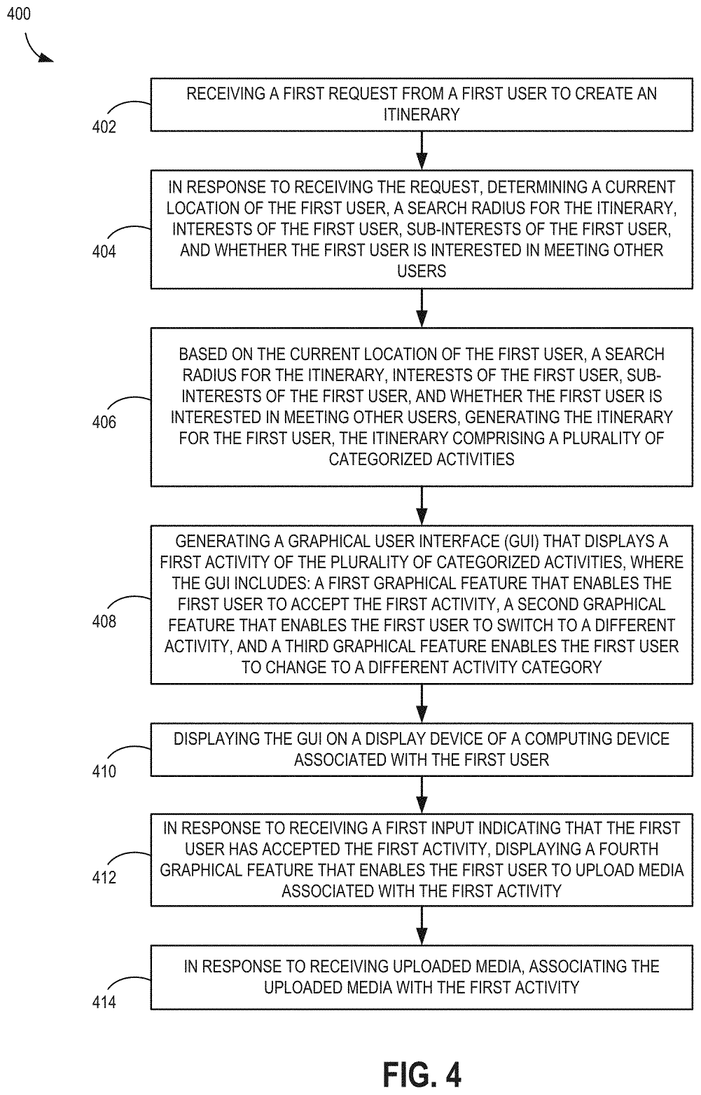

FIG. 4 illustrates a flowchart of an example method 400, according to some implementations. For clarity of presentation, the description that follows generally describes the method 400 in the context of the other figures in this description. For example, the method 400 can be performed by the system 500 shown in FIG. 5. However, it will be understood that the method 400 can be performed, for example, by any suitable system, environment, software, and hardware, or a combination of systems, environments, software, and hardware, as appropriate. In some implementations, various steps of the method 400 can be run in parallel, in combination, in loops, or in any order.

At 402, the method 400 involves receiving a first request from a first user to create an itinerary.

At 404, the method 400 involves in response to receiving the request, determining a current location of the first user, a search radius for the itinerary, interests of the first user, sub-interests of the first user, and whether the first user is interested in meeting other users.

At 406, the method 400 involves based on the current location of the first user, a search radius for the itinerary, interests of the first user, sub-interests of the first user, and whether the first user is interested in meeting other users, generating the itinerary for the first user, the itinerary comprising a plurality of categorized activities.

At 408, the method 400 involves generating a graphical user interface (GUI) that displays a first activity of the plurality of categorized activities. The first activity is associated with an activity category. The GUI includes a first graphical feature that enables the first user to accept the first activity, a second graphical feature that enables the first user to switch to a different activity, and a third graphical feature enables the first user to change to a different activity category.

At 410, the method 400 involves displaying the GUI on a display device of a computing device associated with the first user.

At 412, the method 400 involves in response to receiving a first input indicating that the first user has accepted the first activity, displaying a fourth graphical feature that enables the first user to upload media associated with the first activity.

At 414, the method 400 involves in response to receiving uploaded media, associating the uploaded media with the first activity.

In some implementations, the method 400 further including: in response to receiving a second input indicating to switch to the different activity, determining a second activity of the plurality of categorized activities that is associated with the activity category; and displaying information indicative of the second activity on the GUI.

In some implementations, the method 400 further including: in response to receiving a second input indicating to change to the different activity category, determining a second activity of the plurality of categorized activities that is associated with the different activity category; and displaying information indicative of the second activity on the GUI.

In some implementations, the first activity is a meeting with a second user, and generating the itinerary for the first user includes: determining first meeting preferences for the first user, the first meeting preferences comprising at least one of location for the meeting, food preferences, personal preferences, number of people in the first user's party, number of people that the first user is interested in meeting, a type of meetup, or the first user's schedule availability; determining second meeting preferences for the second user; and executing a matching algorithm that uses the first and second meeting preferences to match the first user with the second user.

In some implementations, the method 400 further including: receiving at least one pre-generated itinerary from a database, each pre-generated itinerary associated with at least one location and comprising one or more predetermined activities; generating a second GUI that provides the at least one pre-generated itinerary; and receiving a second input indicative of selection of one of the at least one pre-generated itinerary.

In some implementations, the method 400 further including determining that the itinerary has been completed; and in response, generating a video based on at least one of the itinerary or the media uploaded by the user, wherein the video highlights the itinerary.

In some implementations, the method 400 further including displaying a fifth graphical feature that enables the first user to play the generated video; and in response to receiving a second input indicating to play the generated video, playing the generated video on the GUI.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML, page) to a client device (e.g., for purposes of displaying data to and receiving user input from a user interacting with the client device). Data generated at the client device (e.g., a result of the user interaction) can be received from the client device at the server.

An example of one such type of computer is shown in FIG. 5, which shows a block diagram of a programmable processing system (system). The system 500 that can be utilized to implement the systems and methods described herein. The architecture of the system 500 can, for example, be used to implement a computer client, a computer server, or some other computer device.

The system 500 includes a processor 510, a memory 520, a storage device 530, and an input/output device 540. Each of the components 510, 520, 530, and 540 can, for example, be interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more of a network interface device, e.g., an Ethernet card, a serial communication device, e.g., an RS-232 port, and/or a wireless interface device, e.g., an 802.11 card. In another implementation, the input/output device can include driver devices configured to receive input data and send output data to other input/output devices, e.g., keyboard, printer and display devices 560.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a first request from a first user to create an itinerary;
in response to receiving the request, determining a current location of the first user, a search radius for the itinerary, interests of the first user, sub-interests of the first user, and whether the first user is interested in meeting other users;
based on the current location of the first user, a search radius for the itinerary, interests of the first user, sub-interests of the first user, and whether the first user is interested in meeting other users, generating the itinerary for the first user, the itinerary comprising a plurality of categorized activities;
generating a graphical user interface (GUI) that displays a first activity of the plurality of categorized activities, wherein the first activity is associated with an activity category, and wherein the GUI includes: a first graphical feature that enables the first user to accept the first activity, a second graphical feature that enables the first user to switch to a different activity, and a third graphical feature enables the first user to change to a different activity category;
displaying the GUI on a display device of a computing device associated with the first user;
in response to receiving a first input indicating that the first user has accepted the first activity, displaying a fourth graphical feature that enables the first user to upload media associated with the first activity; and
in response to receiving uploaded media, associating the uploaded media with the first activity.

2. The computer-implemented method of claim 1, further comprising:
in response to receiving a second input indicating to switch to the different activity, determining a second activity of the plurality of categorized activities that is associated with the activity category; and
displaying information indicative of the second activity on the GUI.

3. The computer-implemented method of claim 1, further comprising:
in response to receiving a second input indicating to change to the different activity category, determining a second activity of the plurality of categorized activities that is associated with the different activity category; and
displaying information indicative of the second activity on the GUI.

4. The computer-implemented method of claim 1, wherein the first activity is a meeting with a second user, and wherein generating the itinerary for the first user comprises:
determining first meeting preferences for the first user, the first meeting preferences comprising at least one of location for the meeting, food preferences, personal preferences, number of people in the first user's party, number of people that the first user is interested in meeting, a type of meetup, or the first user's schedule availability;
determining second meeting preferences for the second user; and
executing a matching algorithm that uses the first and second meeting preferences to match the first user with the second user.

5. The computer-implemented method of claim 1, further comprising:
receiving at least one pre-generated itinerary from a database, each pre-generated itinerary associated with at least one location and comprising one or more predetermined activities;
generating a second GUI that provides the at least one pre-generated itinerary; and
receiving a second input indicative of selection of one of the at least one pre-generated itinerary.

6. The computer-implemented method of claim 1, further comprising:
determining that the itinerary has been completed; and
in response, generating a video based on at least one of the itinerary or the media uploaded by the user, wherein the video highlights the itinerary.

7. The computer-implemented method of claim 6, further comprising:
displaying a fifth graphical feature that enables the first user to play the generated video; and
in response to receiving a second input indicating to play the generated video, playing the generated video on the GUI.

8. A system comprising:
a memory storing instructions;
at least one hardware processor interoperably coupled with the memory, wherein the instructions instruct the at least one hardware processor to perform operations comprising:
receiving a first request from a first user to create an itinerary;
in response to receiving the request, determining a current location of the first user, a search radius for the itinerary, interests of the first user, sub-interests of the first user, and whether the first user is interested in meeting other users;
based on the current location of the first user, a search radius for the itinerary, interests of the first user, sub-interests of the first user, and whether the first user is interested in meeting other users, generating the itinerary for the first user, the itinerary comprising a plurality of categorized activities;
generating a graphical user interface (GUI) that displays a first activity of the plurality of categorized activities, wherein the first activity is associated with an activity category, and wherein the GUI includes: a first graphical feature that enables the first user to accept the first activity, a second graphical feature that enables the first user to switch to a different activity, and a third graphical feature enables the first user to change to a different activity category;
displaying the GUI on a display device of a computing device associated with the first user;
in response to receiving a first input indicating that the first user has accepted the first activity, displaying a fourth graphical feature that enables the first user to upload media associated with the first activity; and
in response to receiving uploaded media, associating the uploaded media with the first activity.

9. The system of claim 8, the operations further comprising:
in response to receiving a second input indicating to switch to the different activity, determining a second activity of the plurality of categorized activities that is associated with the activity category; and
displaying information indicative of the second activity on the GUI.

10. The system of claim 8, the operations further comprising:
in response to receiving a second input indicating to change to the different activity category, determining a second activity of the plurality of categorized activities that is associated with the different activity category; and
displaying information indicative of the second activity on the GUI.

11. The system of claim 8, wherein the first activity is a meeting with a second user, and wherein generating the itinerary for the first user comprises:
determining first meeting preferences for the first user, the first meeting preferences comprising at least one of location for the meeting, food preferences, personal preferences, number of people in the first user's party, number of people that the first user is interested in meeting, a type of meetup, or the first user's schedule availability;
determining second meeting preferences for the second user; and
executing a matching algorithm that uses the first and second meeting preferences to match the first user with the second user.

12. The system of claim 8, the operations further comprising:
receiving at least one pre-generated itinerary from a database, each pre-generated itinerary associated with at least one location and comprising one or more predetermined activities;
generating a second GUI that provides the at least one pre-generated itinerary; and
receiving a second input indicative of selection of one of the at least one pre-generated itinerary.

13. The system of claim 8, the operations comprising:
determining that the itinerary has been completed; and
in response, generating a video based on at least one of the itinerary or the media uploaded by the user, wherein the video highlights the itinerary.

14. The system of claim 13, the operations further comprising:
displaying a fifth graphical feature that enables the first user to play the generated video; and
in response to receiving a second input indicating to play the generated video, playing the generated video on the GUI.

15. A non-transitory computer-readable medium storing one or more instructions executable by a computer system to perform operations comprising:
receiving a first request from a first user to create an itinerary;
in response to receiving the request, determining a current location of the first user, a search radius for the itinerary, interests of the first user, sub-interests of the first user, and whether the first user is interested in meeting other users;
based on the current location of the first user, a search radius for the itinerary, interests of the first user, sub-interests of the first user, and whether the first user is interested in meeting other users, generating the itinerary for the first user, the itinerary comprising a plurality of categorized activities;
generating a graphical user interface (GUI) that displays a first activity of the plurality of categorized activities, wherein the first activity is associated with an activity category, and wherein the GUI includes: a first graphical feature that enables the first user to accept the first activity, a second graphical feature that enables the first user to switch to a different activity, and a third graphical feature enables the first user to change to a different activity category;
displaying the GUI on a display device of a computing device associated with the first user;
in response to receiving a first input indicating that the first user has accepted the first activity, displaying a fourth graphical feature that enables the first user to upload media associated with the first activity; and
in response to receiving uploaded media, associating the uploaded media with the first activity.

16. The non-transitory computer-readable medium of claim 15, the operations further comprising:
in response to receiving a second input indicating to switch to the different activity, determining a second activity of the plurality of categorized activities that is associated with the activity category; and
displaying information indicative of the second activity on the GUI.

17. The non-transitory computer-readable medium of claim 15, the operations further comprising:
in response to receiving a second input indicating to change to the different activity category, determining a second activity of the plurality of categorized activities that is associated with the different activity category; and
displaying information indicative of the second activity on the GUI.

18. The non-transitory computer-readable medium of claim 15, wherein the first activity is a meeting with a second user, and wherein generating the itinerary for the first user comprises:
determining first meeting preferences for the first user, the first meeting preferences comprising at least one of location for the meeting, food preferences, personal preferences, number of people in the first user's party, number of people that the first user is interested in meeting, a type of meetup, or the first user's schedule availability;
determining second meeting preferences for the second user; and
executing a matching algorithm that uses the first and second meeting preferences to match the first user with the second user.

19. The non-transitory computer-readable medium of claim 15, the operations further comprising:
receiving at least one pre-generated itinerary from a database, each pre-generated itinerary associated with at least one location and comprising one or more predetermined activities;
generating a second GUI that provides the at least one pre-generated itinerary; and
receiving a second input indicative of selection of one of the at least one pre-generated itinerary.

20. The non-transitory computer-readable medium of claim 15, the operations further comprising:
determining that the itinerary has been completed; and
in response, generating a video based on at least one of the itinerary or the media uploaded by the user, wherein the video highlights the itinerary.
